(19) United States
(12) Patent Application Publication
(10) Pub. No.: US 2005/0200422 A1
(43) Pub. Date: Sep. 15, 2005

(54) Tunable filters having variable bandwidth and variable delay

(76) Inventors: Khosro Shamsaifar, Ellicott City, MD (US); Yongfei Zhu, Ellicott City, MD (US); John Kvarnstrand, Columbia, MD (US); Louise C. Sengupta, Ellicott City, MD (US)

Correspondence Address: James S. Finn;C/O William Tucker, Box #8, 14431 Goliad Dr., Malakoff, TX, 75148, US

(21) Appl. No.: 11/068,453

(22) Filed: Feb. 25, 2005

Related U.S. Application Data
(63) Continuation-in-part of application No. 10/912,284, filed on Aug. 5, 2004.
Application No. 10/912,284 is a continuation-in-part of application No. 10/252,139, filed on Sep. 20, 2002, now Pat. No. 6,801,102.
(60) Provisional application No. 60/323,729, filed on Sep. 20, 2001.

(51) Int. Cl. H04B 3/04

(52) U.S. Cl. 333/17.1

(57) ABSTRACT

An embodiment of the present invention further provides an apparatus capable of reducing selected signal components in a communication link comprising a signal line conveying a communication signal including a desired signal component and at least one undesired signal component; a first signal loop coupled to the first signal line capable of generating a signal such that when combined with the first signal line reduces a first of the at least one undesired signal components; and a second signal loop coupled to the first signal line capable of generating a signal such that when combined with the first signal line reduces a second of the at least one undesired signal components. The first signal loop may include a tunable delay enabling the generation of the signal that when combined with the first signal line reduces a first of the at least one undesired signal components. Further, the second signal loop may include a tunable delay enabling the generation of the signal that when combined with the first signal line reduces a second of the at least one undesired signal components. The first of the at least one undesired signal components may be intermodulation distortion and the adding of a signal generated by the first signal loop may reduce or eliminate it. Further, a second of the at least one undesired signal components may be receive signal distortion and the adding of a signal generated by the second signal loop may reduce or eliminate it.

### CROSS REFERENCED TO RELATED APPLICATIONS

This application is a Continuation in Part of U.S. application Ser. No. 10/912,284; filed Aug. 8, 2004, which is a Continuation-in-Part of U.S. Application Serial No. 10/252,139; filed Sep. 20, 2002, which claims benefit of Provisional patent application Ser. No. 60/323,729, filed Sep. 20, 2001.

### BACKGROUND OF THE INVENTION

Electrically tunable filters have many uses in microwave and radio frequency systems. Compared to mechanically and magnetically tunable filters, electronically tunable filters have the important advantage of fast tuning capability over wide band application. Because of this advantage, they can be used in the applications such as, by way of example and not by way of limitation, LMDS (local multipoint distribution service), PCS (personal communication system), frequency hopping, satellite communication, and radar systems.

Filters for use in radio link communications systems have been required to provide better performance with smaller size and lower cost. Significant efforts have been made to develop new types of resonators, new coupling structures and new configurations for the filters. In some applications where the same radio is used to provide different capacities in terms of Mbits/sec, the intermediate frequency (IF) filter's bandwidth has to change accordingly. In other words, to optimize the performance of radio link for low capacity radios, a narrow band IF filter is used while for higher capacities wider band IF filters are needed. This requires using different radios for different capacities, because they have to use different IF filters. However, if the bandwidth of the IF filter could be varied electronically, the same configuration of radio could be used for different capacities which will help to simplify the architecture of the radio significantly, as well as reduce cost.

Traditional electronically tunable filters use semiconductor diode varactors to change the coupling factor between resonators. Since a diode varactor is basically a semiconductor diode, diode varactor-tuned filters can be used in various devices such as monolithic microwave integrated circuits (MMIC), microwave integrated circuits or other devices. The performance of varactors is defined by the capacitance ratio, Cmax/Cmin, frequency range, and figure of merit, or Q factor at the specified frequency range. The Q factors for semiconductor varactors for frequencies up to 2 GHz are usually very good. However, at frequencies above 2 GHz, the Q factors of these varactors degrade rapidly.

Since the Q factor of semiconductor diode varactors is low at high frequencies (for example, <20 at 20 GHz), the insertion loss of diode varactor-tuned filters is very high, especially at high frequencies (>5 GHz). Another problem associated with diode varactor-tuned filters is their low power handling capability. Further, since diode varactors are nonlinear devices, their handling of signals may generate harmonics and subharmonics.

Commonly owned U.S. patent application Ser. No. 09/419,219, filed Oct. 15, 1999, and titled “Voltage Tunable Varactors And Tunable Devices Including Such Varactors”, discloses voltage tunable dielectric varactors that operate at room temperature and various devices that include such varactors, and is hereby incorporated by reference. Compared with the traditional semiconductor diode varactors, dielectric varactors have the merits of lower loss, higher power-handling, higher IP3, and faster tuning speed.

High power amplifiers are also an important part of any radio link. They are required to output maximum possible power with minimum distortion. One way to achieve this is to use feed forward amplifier technology. A typical feed forward amplifier includes two amplifiers (the main and error amplifiers), directional couplers, delay lines, gain and phase adjustment devices, and loop control networks. The main amplifier generates a high power output signal with some distortion while the error amplifier produces a low power distortion-cancellation signal.

In a typical feed forward amplifier, a radio frequency (RF) signal is input into a power splitter. One part of the RF signal goes to the main amplifier via a gain and phase adjustment device. The output of the main amplifier is a higher level, distorted carrier signal. A portion of this amplified and distorted carrier signal is extracted using a directional coupler, and after going through an attenuator, reaches a carrier cancellation device at a level comparable to the other part of the signal that reaches carrier cancellation device after passing through a delay line. The delay line is used to match the timing of both paths before the carrier cancellation device. The output of carrier cancellation device is a low level error or distortion signal. This signal, after passing through another gain and phase adjustment device, gets amplified by the low power amplifier. This signal is then subtracted from the main distorted signal with an appropriate delay to give the desired non-distorted output carrier.

Traditionally, delay lines have been used to give the desired delay and provide the above-described functionality. However, delay filters have become increasingly popular for this application because they are smaller, easily integrated with other components, and have lower insertion loss, as compared to their delay line counterpart. A fixed delay filter can be set to give the best performance over the useable bandwidth. This makes the operation of a feed forward amplifier much easier, as compared to the tuning of a delay line, which simulates adjustment of the physical length of a cable. However, fixed delay filters still have to be tuned manually.

The use of Feedforward techniques to reduce intermodulation distortion, caused by the power amplifier in the Tx path is well known. However, there is a strong need for reducing the noise signal in the Rx band thereby relaxing the rejection requirement of the Tx filter in a Duplexer and decreasing the insertion loss,

### SUMMARY OF THE INVENTION

An embodiment of the present invention provides an apparatus, comprising a transceiver with a feed forward amplifier including a plurality of cancellation loops, wherein at least one of the plurality of cancellation loops includes a tunable filter enabling the noise signal in a Rx band to be reduced. Further, at least one of the plurality of cancellation loops may include a tunable filter which provides the capability to reduce intermodulation signals and the tunable filter may include a voltage tunable dielectric material to enable the tuning.

The cancellation loop which includes a tunable delay enabling the noise signal in a Rx band to be reduced may further include a Rx filter preceding the tunable delay and a power amplifier after the tunable delay thereby enabling a signal capable of canceling any noise signals input into the apparatus. The cancellation of any noise signal input into the apparatus may be accomplished by the signal generated in the cancellation loop being approximately 180 degrees out of phase and of equal amplitude to the input signal and being added to the input signal. The generation of the signal being approximately 180 degrees out of phase with the input signal may be accomplished by applying the voltage tunable delay within the cancellation loop to the signal to which is to be combined with the input signal.

An embodiment of the present invention further provides an apparatus capable of reducing selected signal components in a communication link comprising a signal line conveying a communication signal including a desired signal component and at least one undesired signal component; a first signal loop coupled to the first signal line capable of generating a signal such that when combined with the first signal line reduces a first of the at least one undesired signal components; and a second signal loop coupled to the first signal line capable of generating a signal such that when combined with the first signal line reduces a second of the at least one undesired signal components. The first signal loop may include a tunable delay enabling the generation of the signal that when combined with the first signal line reduces a first of the at least one undesired signal components. Further, the second signal loop may include a tunable delay enabling the generation of the signal that when combined with the first signal line reduces a second of the at least one undesired signal components. The first of the at least one undesired signal components may be intermodulation distortion and the adding of a signal generated by the first signal loop may reduce or eliminate it. Further, a second of the at least one undesired signal components may be receive signal distortion and the adding of a signal generated by the second signal loop may reduce or eliminate it.

The tunable delay may be tuned by using a voltage tunable dielectric material and the signal line may be coupled with a first signal source. The desired signal component may be a transmission signal and the at least one undesired signal component may be a received signal and an intermodulation distortion generated by signal line components operating on the communication signal.

Yet another embodiment of the present invention provides a method of reducing selected signal components in a communication link comprising conveying a communication signal including a desired signal component and at least one undesired signal component; combining a signal generated by a first signal loop with the communication signal such that when combined a reduction or elimination of a first of the at least one undesired signal components occurs; and combining a signal generated by a second signal loop with the communication signal such that when combined a reduction or elimination of a second of the at least one undesired signal components occurs.

The present method may further comprise applying a tunable delay within the first signal loop thereby enabling the generation of a signal that when combined with the communication signal reduces a first of the at least one undesired signal components or may further comprise applying a tunable delay within the second signal loop thereby enabling the generation of a signal that when combined with the communication signal reduces a second of the at least one undesired signal components. The tunable delay may be tuned by using a voltage tunable dielectric material such as, but not limited to, Parascan® dielectric material.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 provides a feed forward power amplifier diagram capable of reducing intermodulation distortion and Rx noise;

FIG. 2 illustrates the signal spectrum at the input with Tx signal and Rx noise of one embodiment of the present invention;

FIG. 3 illustrates the signal spectrum at point a of FIG. 1 with Tx signal and Rx noise and Intermodulation signals;

FIG. 4 illustrates the signal spectrum at point b of FIG. 1 with Intermodulation signals;

FIG. 5 illustrates the signal spectrum at point c of FIG. 1 with the Tx signal and Rx noise amplified; and

FIG. 6 illustrates the signal spectrum at point d of FIG. 1 with the Rx noise.

### DESCRIPTION OF THE PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Intermodulation distortion caused by a power amplifier in a Tx path is problematic and Feedforward techniques to reduce or overcome this have been developed. The parent application to the present application discloses a tunable delay line used in the feed forward cancellation loop, based on BST tunable dielectric material and provides significant reduction of intermodulation signals. This application is set forth in the Cross Reference Section and is incorporated into the present application by reference. The present invention provides further improvement by adding at least one additional loop which enables the noise signal in the Rx band to be reduced, which helps relax the rejection requirement of the Tx filter in the Duplexer and decreases the insertion loss, thereby increasing the output power. Thus, an embodiment of the present invention provides a feed forward amplifier with a plurality of cancellation loops (such as, but not limited to, two cancellation loops) to reduce intermodulation distortion and Rx band noise when amplifying the Tx band signal.

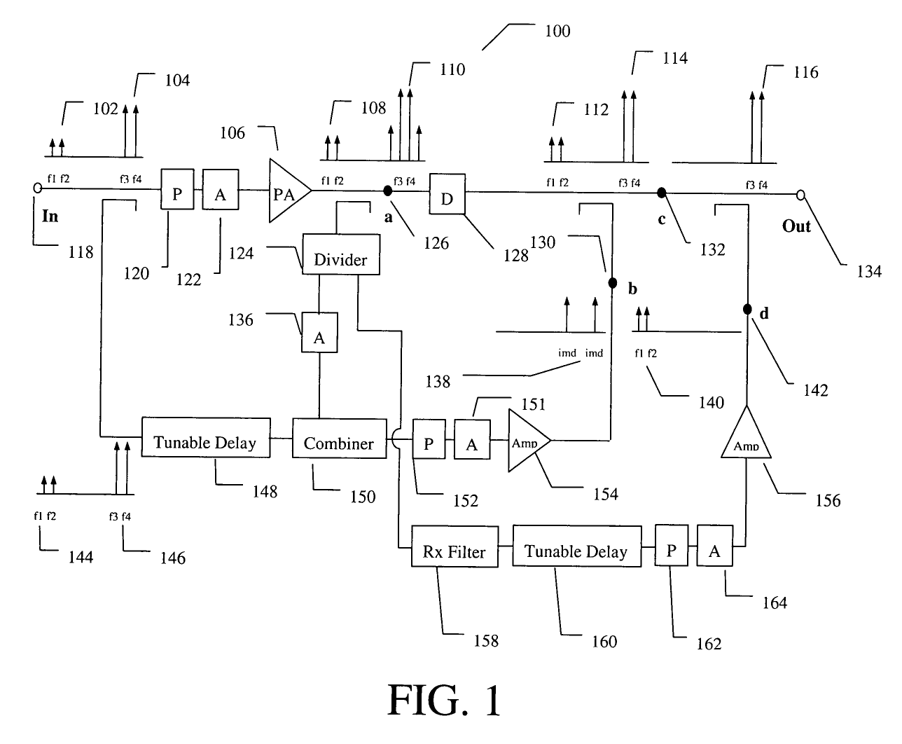

Rx band noise signals may also be amplified and transferred to the duplexer. These signals enter the receiver without attenuation and will decrease signal to noise ratio (SNR) of the receiver. This could be avoided by increasing the isolation between Tx and Rx in the Duplexer, but it would require front end filters with more rejection, with associated higher insertion loss. In an embodiment of the present invention, in an alternative approach is used a second loop in feedforward amplifier to reduce this noise as shown generally as 100 of FIG. 1; which depicts a feed forward power amplifier diagram capable of reducing intermodulation distortion and Rx noise with input 118 with Tx signal 104 and Rx noise 102 of one embodiment of the present invention. The input signal 118 in the transmit path contains Tx signal 104, and some noise 102 in the Rx band: f1 and f2 (102) are two tones of noise in Rx band and f3 and f4 (104) are two tones in Tx band.

This signal, after some amplitude 122 and phase 120 adjustment, will reach the main power amplifier, PA 106. The PA 106 will amplify the Tx signal 104, the Rx noise 102, and will generate some intermodulation signals as shown by 108 and 110 with Tx signal with intermodulation 110 and Rx noise 108.

A portion of signal a 126 is coupled off and then divided in two halves by a divider 124 (such as, but not limited to, a Wilkinson divider). One half will go to the combiner 150 after some amplitude adjustments 136. At the input 118, a portion of the input signal will be coupled off and after passing through the tunable delay line 148 will be subtracted from the signal coming from point a 126. The signal f1 and f2 are depicted as 144 and f3 and f4 at 146. The output of the combiner 150 will therefore contain only the intermodulation signal 138. This is achieved when the two signals reaching the combiner 150 have exactly the same amplitude, and are out of phase. The presence of tunable delay line 148 may enable this wide band cancellation. This signal, after some amplitude 151 and phase 152 adjustments will be amplified by an error amplifier, Amp 154, and is shown at point b 130.

The signal at point b 130 will then be coupled, or subtracted from signal a 126 to give signal c 132 without intermodulation distortion, as shown at 116. The cancellation is achieved, when the amplitude of this signal is exactly equal to the amplitude of intermodulation signal at point a 126 with 180 phase shift.

It is observed that the noise in the receive band, f1 and f2 (112), are still present at point c 132 with Tx signal depicted as 114. The purpose of the second loop is to eliminate this noise, as described follows: The other half of signal a 126 from Divider 124 will go through a bandpass filter 158 at the frequency of Rx. This filter 158 will reject Tx signals and intermodulation signals. Alternatively, a notch filter could be used to reject the Tx spectrum. This signal, after going through a tunable delay line 160, phase shifter P 162, and attenuator A 164, will be amplified using an error amplifier Amp 156. Parascan® material may be used in either or both the tunable delays for achieving wide band cancellation and to compensate for any temperature drift in other components of the loop.

The term Parascan® as used herein is a trademarked term indicating a tunable dielectric material developed by the assignee of the present invention. Parascan® tunable dielectric materials have been described in several patents. Barium strontium titanate (BaTiO3—SrTiO3), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,312,790 to Sengupta, et al. entitled “Ceramic Ferroelectric Material”; U.S. Pat. No. 5,427,988 by Sengupta, et al. entitled “Ceramic Ferroelectric Composite Material-BSTO-MgO”; U.S. Pat. No. 5,486,491 to Sengupta, et al. entitled “Ceramic Ferroelectric Composite Material—BSTO-ZrO2”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO-ZnO”; U.S. Pat. No. 6,074,971 by Chiu et al. entitled “Ceramic Ferroelectric Composite Materials with Enhanced Electronic Properties BSTO Mg Based Compound-Rare Earth Oxide”. These patents are incorporated herein by reference. The materials shown in these patents, especially BSTO-MgO composites, show low dielectric loss and high tunability. Tunability is defined as the fractional change in the dielectric constant with applied voltage.

Barium strontium titanate of the formula BaxSr1—xTiO3 is a preferred electronically tunable dielectric material due to its favorable tuning characteristics, low Curie temperatures and low microwave loss properties. In the formula BaxSr1—xTiO3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is BaxCa1—xTiO3, where x is in a range from about 0.2 to about 0.8, preferably from about 0.4 to about 0.6. Additional electronically tunable ferroelectrics include PbxZr1—xTiO3 (PZT) where x ranges from about 0.0 to about 1.0, PbxZr1—xSrTiO3 where x ranges from about 0.05 to about 0.4, KTaxNb1—xO3 where x ranges from about 0.0 to about 1.0, lead lanthanum zirconium titanate (PLZT), PbTiO3, BaCaZrTiO3, NaNO3, KNbO3, LiNbO3, LiTaO3, PbNb2O6, PbTa2O6, KSr(NbO3) and NaBa2(NbO3)5 KH2PO4, and mixtures and compositions thereof. Also, these materials can be combined with low loss dielectric materials, such as magnesium oxide (MgO), aluminum oxide (Al2O3), and zirconium oxide (ZrO2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. Patent Applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. Provisional Application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl2O4, MgTiO3, Mg2SiO4, CaSiO3, MgSrZrTiO6, CaTiO3, Al2O3, SiO2 and/or other metal silicates such as BaSiO3 and SrSiO3. The non-tunable dielectric phases may be any combination of the above, e.g., MgO combined with MgTiO3, MgO combined with MgSrZrTiO6, MgO combined with Mg2SiO4, MgO combined with Mg2SiO4, Mg2SiO4 combined with CaTiO3 and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO3, BaZrO3, SrZrO3, BaSnO3, CaSnO3, MgSnO3, Bi2O3/2SnO2, Nd2O3, Pr7O11, Yb2O3, Ho2O3, La2O3, MgNb2O6, SrNb2O6, BaNb2O6, MgTa2O6, BaTa2O6 and Ta2O3.

Thick films of tunable dielectric composites may comprise Ba1—xSrxTiO3, where x is from 0.3 to 0.7 in combination with at least one non-tunable dielectric phase selected from MgO, MgTiO3, MgZrO3, MgSrZrTiO6, Mg2SiO4, CaSiO3, MgAl2O4, CaTiO3, Al2O3, SiO2, BaSiO3 and SrSiO3. These compositions can be BSTO and one of these components, or two or more of these components in quantities from 0.25 weight percent to 80 weight percent with BSTO weight ratios of 99.75 weight percent to 20 weight percent.

The electronically tunable materials may also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg2SiO4, CaSiO3, BaSiO3 and SrSiO3. In addition to Group 2A metals, the present metal silicates may include metals from Group 1A, i.e., Li, Na, K, Rb, Cs and Fr, preferably Li, Na and K. For example, such metal silicates may include sodium silicates such as Na2SiO3 and NaSiO3—5H2O, and lithium-containing silicates such as LiAlSiO4, Li2SiO3 and Li4SiO4. Metals from Groups 3A, 4A and some transition metals of the Periodic Table may also be suitable constituents of the metal silicate phase. Additional metal silicates may include Al2Si2O7, ZrSiO4, Ka1Si3O8, NaAlSi3O8, CaAl2Si2O8, CaMgSi2O6, BaTiSi3O9 and Zn2SiO4. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides. Preferred additional metal oxides include Mg2SiO4, MgO, CaTiO3, MgZrSrTiO6, MgTiO3, MgAl2O4, WO3, SnTiO4, ZrTiO4, CaSiO3, CaSnO3, CaWO4, CaZrO3, MgTa2O6, MgZrO3, MnO2, PbO, Bi2O3 and La2O3. Particularly preferred additional metal oxides include Mg2SiO4, MgO, CaTiO3, MgZrSrTiO6, MgTiO3, MgAl2O4, MgTa2O6 and MgZrO3.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

The additional metal oxide phases can include at least two Mg-containing compounds. In addition to the multiple Mg-containing compounds, the material may optionally include Mg-free compounds, for example, oxides of metals selected from Si, Ca, Zr, Ti, Al and/or rare earths.

The signal at point d 142 only contains the Rx noise signal f1 and f2 140. Similar to the first cancellation loop, the signal at point d 142 will be subtracted from the signal at pint c 132 resulting in the output transmit signal 134 containing only the Tx tones f3 and f4 116.

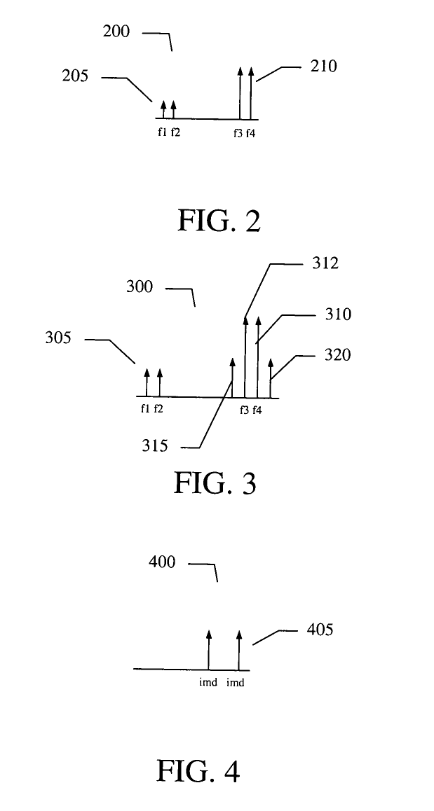

FIGS. 2-6 further illustrate the signals at various stages of the diagram of FIG. 1. Turning to FIG. 2, illustrated generally at 200 is shown the signal spectrum at the input with Tx signal 210 and Rx noise 205 of one embodiment of the present invention. FIG. 3, generally at 300, illustrates the signal spectrum at point a 126 of FIG. 1 with Tx signal 310 and 312 and Rx noise 305 and Intermodulation signals 315 and 320 of one embodiment of the present invention;

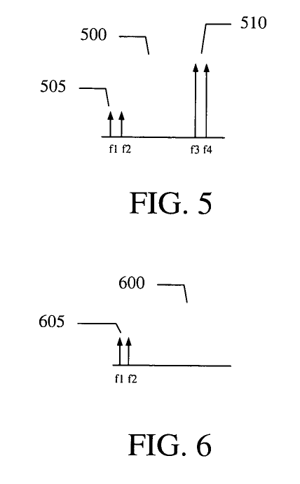

FIG. 4 illustrates generally at 400, the signal spectrum at point b 130 of FIG. 1 with Intermodulation signals 405. FIG. 5 illustrates generally at 500 the signal spectrum at point c 132 of FIG. 1 with the Tx signal 510 and Rx noise 505 amplified. FIG. 6 illustrates generally at 600 the signal spectrum at point d 142 of FIG. 1 with the Rx noise 605.

While the present invention has been described in terms of what are at present believed to be its preferred embodiments, those skilled in the art will recognize that various modifications to the disclose embodiments can be made without departing from the scope of the invention as defined by the following claims.

1. An apparatus, comprising:
a transceiver including a plurality of cancellation loops, wherein at least one of said plurality of cancellation loops includes a tunable delay enabling the noise signal in a Rx band to be reduced.

2. The apparatus of claim 1, wherein at least one of said plurality of cancellation loops includes a tunable delay which provides the capability to reduce intermodulation signals.

3. The apparatus of claim 1, where said tunable delay includes a voltage tunable dielectric material to enable said tuning.

4. The apparatus of claim 1, wherein said cancellation loop which includes a tunable delay enabling the noise signal in a Rx band to be reduced further includes a Rx filter preceding said tunable delay and a power amplifier after said tunable delay thereby enabling a signal capable of canceling any noise signals input into said apparatus.

5. The apparatus of claim 5, wherein the cancellation of any noise signal input into said apparatus is accomplished by said signal generated in said cancellation loop being approximately 180 degrees out of phase and of approximately equal amplitude of said input signal and being added to said input signal.

6. The apparatus of claim 5, wherein the generation of said signal being approximately 180 degrees out of phase with said input signal is accomplished by applying said voltage tunable delay within said cancellation loop to the signal to which is to be combined with said input signal.

7. An apparatus capable of reducing selected signal components in a communication link comprising:
a signal line conveying a communication signal including a desired signal component and at least one undesired signal component;
a first signal loop coupled to said first signal line capable of generating a signal such that when combined with said first signal line reduces a first of said at least one undesired signal components; and
a second signal loop coupled to said first signal line capable of generating a signal such that when combined with said first signal line reduces a second of said at least one undesired signal components.

8. The apparatus of claim 7, wherein said first signal loop includes a tunable delay enabling the generation of said signal that when combined with said first signal line reduces a first of said at least one undesired signal components.

9. The apparatus of claim 7, wherein said second signal loop includes a tunable delay enabling the generation of said signal that when combined with said first signal line reduces a second of said at least one undesired signal components.

10. The apparatus of claim 8, wherein said first of said at least one undesired signal components is intermodulation distortion and the adding of a signal generated by said first signal loop reduces said intermodulation distortion.

11. The apparatus of claim 8, wherein said second of said at least one undesired signal components is a received signal and the adding of a signal generated by said second signal loop reduces or eliminated said received signal.

12. The apparatus of claim 8 or claim 9, wherein said tunable delay is tuned by using a voltage tunable dielectric material.

13. The apparatus of claim 7, wherein said signal line is coupled with a first signal source.

14. The apparatus of claim 7, wherein said desired signal component is a transmission signal and said at least one undesired signal component is a received signal and an intermodulation distortion generated by signal line components operating on said communication signal.

15. A method of reducing selected signal components in a communication link comprising:
conveying a communication signal including a desired signal component and at least one undesired signal component;
combining a signal generated by a first signal loop with said communication signal such that, when combined, a reduction or elimination of a first of said at least one undesired signal components occurs; and
combining a signal generated by a second signal loop with said communication signal such that, when combined, a reduction or elimination of a second of said at least one undesired signal components occurs.

16. The method of claim 15, further comprising applying a tunable delay within said first signal loop thereby enabling the generation of a signal that when combined with said communication signal reduces a first of said at least one undesired signal components.

17. The method of claim 15, further comprising applying a tunable delay within said second signal loop thereby enabling the generation of a signal that when combined with said communication signal reduces a second of said at least one undesired signal components.

18. The method of claim 15, wherein said first of said at least one undesired signal components is intermodulation distortion and the adding of a signal generated said first signal loop reduces said intermodulation distortion.

19. The method of claim 15, wherein said second of said at least one undesired signal components is a received signal and the adding of a signal generated by said second signal loop reduces or eliminated said received signal.

20. The method of claim 16 or claim 17, wherein said tunable delay is tuned by using a voltage tunable dielectric material.
